(19) United States
(12) Patent Application Publication
(10) Pub. No.: US 2003/0096606 A1
(43) Pub. Date: May 22, 2003

(54) System and method for determining correlations in a communications network

(76) Inventors: Dwight Inman, Allen, TX (US); Wendy Li, Plano, TX (US); George P. Yost, Austin, TX (US)

Correspondence Address: Daniel J. Chalker, GARDERE WYNNE SEWELL LLP, Suite 3000, 1601 Elm Street, Dallas, TX, 75201-4767, US

(21) Appl. No.: 09/989,628

(22) Filed: Nov. 20, 2001

(51) Int. Cl. H04Q 7/20

(52) U.S. Cl. 455/424; 455/423; 455/436

(57) ABSTRACT

The present invention provides a system and method for determining whether two or more parameters influence one another within a communications network by obtaining a set of measurements for two or more parameters. A correlation and a partial correlation between each of the parameters are then determined. A determination is then made as to whether the correlations and the partial correlations are statistically significant. Thereafter, a determination is made as to whether the two or more parameters, if any, influence one another based on the statistically significant correlations and partial correlations.

### FIELD OF THE INVENTION

The present invention relates generally to the field of communications and, more particularly, to a system and method for determining correlations in a communications network.

### BACKGROUND OF THE INVENTION

The rapid, worldwide expansion of communication networks combined with increased competition among network operators has meant an ever-increasing need for continuous improvement in the quality and accessibility of networks. Network operators use tools to monitor communication networks to identify network problems. For example, operators may use protocol analyzers to statistically monitor the communication networks to measure traffic levels, including broadcast traffic levels, and to detect collisions and errors. The network operators then use the information in an attempt to manually identify network problems and try to correct them.

Many statistics are collected for billing, diagnostic and other purposes in communication networks. Cause and effect relationships between these statistics are difficult to establish because there are a large number of possible causes for each effect. But, diagnosis of a problem requires knowing these exact causes. For example, an increase in the number of dropped calls in a cell could be due to changes in the operating parameters of the cell, changes in the level of interference, changes in the operating parameters of nearby cells, changes in the environment of the cell, or many other things. Many of these changes are not themselves subject to measurement during the normal course of network operation. However, each of these changes may cause characteristic changes in the values of some of the statistics that are collected.

Attempts to determine correlations between various operating parameters are performed by a simple visual scan of the data trends or by attempts to diagnose the problems through hit-or-miss guesswork. However, these correlations can be extremely difficult to spot in a simple visual scan of the fluctuations in call quality statistics and accessibility statistics as a function of time. These effects could be analyzed at a given point in time by looking at the variations in a given set of variables from one cell to another, one cluster of cells to another or one switch to another. Even knowing which of these variables are related to which other variables is often difficult to establish and may vary between networks and even between cells, depending on the situation.

In addition, it is nearly impossible using these methods to separate the variables that have a cause-and-effect relationship to each other from those that are simply fluctuating in concert with some other variable. For instance, if variable A and variable B are independent of each other, but are both dependent on variable C, then changes in C may cause A and B to vary simultaneously as if correlated. Present methods of system diagnosis, visual scans of statistical fluctuations combined with experiential guesswork and a general understanding of the conditions in the system, do not have the ability to determine the connection of C to A and B.

It is also very difficult to scan trending graphs and spot correlated behavior unless the correlations are unusually strong. Moreover, visual analysis is also very labor-intensive and allows numerous false conclusions. False conclusions do not result in problem solutions; they may, in fact, exacerbate the problem by creating new problems, thereby complicating the solution. As a result, false conclusions are costly in terms of time and money. Moreover, the statistical significance of any conclusions reached using the current visual techniques cannot be established. These methods do not allow the application of statistical decision theory to the solution of problems in communications networks. Therefore, the probability of error cannot be minimized. Further, it is nearly impossible to even understand the probabilities of different kinds of errors when all one uses is guesswork based on experience.

Various techniques have been developed to use correlations as a basis of identification of interference sources. For example, techniques that attempt to cross correlate call startups in one cell with interference onset in a co-channel disturbed cell on the basis of coincidence in time. These techniques attempt to determine the source of interference in one cell from timing coincidences between calls in a co-channel cell and the interference in a disturbed cell. In addition, other correlation techniques have been used to identify the sources of interference in cells. These techniques, however, do not enable insight into the fundamentals of system operation through correlations within cells, clusters of cells or networks by relating behavioral variations in one statistic to the variations in other statistics. Moreover, these techniques are usually limited in scope.

Accordingly, there is a need for a system and method for determining correlations in space and/or time between variables or parameters that describe the operation of a communications network. In addition, there is a need for a system and method that minimizes the probability of error, reduces the number of false conclusions, and reduces the amount of labor required to diagnose communications network problems.

### SUMMARY OF THE INVENTION

The present invention provides a system and method for determining correlations in space and/or time between variables or parameters that describe the operation of a communications network. The present invention uses multivariate analysis to establish correlated behavior and measure its extent. It also uses statistical techniques to separate, from a group of measured statistics, those that are directly dependent upon each other and those whose correlation is only derivative of the fact that they jointly depend upon other variables in the same group. The present invention also minimizes the probability of error, reduces the number of false conclusions, and reduces the amount of labor required to diagnose communications network problems.

The present invention provides a method for determining whether two or more parameters influence one another within a communications network. A set of measurements is obtained for two or more parameters within the communications network. A correlation between each of the two or more parameters and, if at least three parameter measurements are taken, a partial correlation between each pair of the parameters is then determined. A determination is then made as to whether the correlations and the partial correlations are statistically significant. Thereafter, a determination is made as to whether the two or more parameters influence one another based on those correlations and partial correlations that are statistically significant. This method can be implemented using a computer program embodied on a computer readable medium by using code segments for each step of the method.

The present invention also provides a system for determining whether two or more parameters influence one another within a communications network. The system includes a computer, a data storage mechanism (such as a database or file) communicably coupled to the computer, and an interface communicably coupled to the computer for communicably coupling the computer to one or more network devices. The computer obtains a set of measurements for the two or more parameters within the communications network, determines a correlation between each of the two or more parameters and, if at least three parameters are taken, a partial correlation between each pair of the parameters, determines whether the correlations and the partial correlations are statistically significant, and determines whether the two or more parameters influence one another based on those correlations and partial correlations that are statistically significant.

Other features and advantages of the present invention shall be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is an illustration of a communications network in accordance with the prior art;

FIG. 2 is an illustration of the use of an error ellipse in accordance with one embodiment of the present invention;

FIG. 3 is a flowchart illustrating the process of one embodiment of the present invention;

FIG. 4A is a graph of a correlation between two parameters (dropped handoffs and designation failures) in a communications network using the present invention;

FIG. 4B is a graph of a correlation between two parameters (dropped handoffs and digital page failures) in a communications network using the present invention; and

FIG. 4C is a graph of a correlation between two parameters (digital page failures and designation failures) in a communications network using the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The discussion herein relates to communications networks, and more particularly, to a system and method for applying correlations to a communications network. It will be understood that, although the description herein refers to a communications environment, the concepts of the present invention are applicable to any stochastic environment.

The present invention provides a system and method for determining correlations in space and/or time between variables or parameters that describe the operation of a communications network. The present invention uses multivariate analysis to establish correlated behavior and measure its extent. It also uses statistical techniques to separate, from a group of measured parameters, those that are directly dependent upon each other and those whose correlation is only derivative of the fact that they jointly depend upon other parameters in the same group. The present invention also minimizes the probability of error, reduces the number of false conclusions, and reduces the amount of labor required to diagnose communications network problems.

Correlations can be revealing as to the cause of operational problems within a communications network. For example, an operator alters the parameter that sets the minimum signal strength for a call to access the network. This will result in a change in the rate of access failures according to whether the minimum was increased or decreased. Additionally, this will affect the average quality of the calls. If calls with lower signal strength are allowed access, then the quality will decrease and vice versa. On a large-scale level where that parameter is changed frequently for cells in the network, a negative (inverse) correlation between call quality and call accessibility might be expected. This may be the opposite of what would be expected if there were other causes for most of the accessibility failures or calls with poor quality. If, for example, the radio environment of the cells becomes increasingly bad (e.g., due to increasing noise or interference), it is expected that accessibility will get worse and call quality will also get worse (i.e., a positive correlation).

The present invention allows the determination of such multivariable correlations. For example, neither call accessibility nor call quality can be said to cause each other to change; it is the changes in a third parameter, minimum signal strength to access the system, that make both call accessibility and call quality to vary. A third statistic, changes to the third parameter, assists the operator in establishing a direct link to the call quality and the accessibility. Moreover, it can be established using the present invention that call quality and accessibility are correlated to each other only through the intervention of the third parameter.

The present invention uses correlation analysis or regression analysis to help analyze the behavior of radio frequency networks, such as mobile phone networks, to obtain a deeper insight into what is going on. As a result, the present invention allows a determination to be made as to the source of a particular type of problem that an operator is experiencing in the communications network. The typical type of problem is represented by a loss of performance in some measure, parameter or variable, typically referred to as a key performance indicator. Instead of relying on brute force in the form of combined intuition and experience, perhaps coupled with trial and error, to determine the source of the degradation, the present invention looks at statistical measures of the various things that are occurring and focuses on correlations between the measurement of the problem and measurements of other operating indicators.

Generally, communication network operators, such as cellular carriers, measure key performance indicators for the entire system. From these key performance indicators, the present invention creates matrices of correlations between the indicators. These parameters or key performance indicators may include network accessibility, service quality, dropped bandoffs, designated failures, digital page failures, and others. Communication network operators usually set up switches and other network devices to automatically collect data so that they can monitor the network. The switches or network devices can also be setup to collect a special type of data or collect data on demand. The collected data may be stored in and retrieved from a data storage mechanism, such as a database, designated file in an appropriate format or any other type of data storage medium. The present invention can use the data routinely stored by the network operator or can use data collected for a specific analysis.

The present invention requires that a significant amount of data is available for the analysis, like a certain number of measurements or for a specified time period. Additionally, in order to perform a relevant correlation, conditions must vary. In other words, the present invention looks for behavior that tracks other behavior. For example, if there is an accessibility problem, then the present invention studies the key performance indicator for accessibility and finds what other key performance indicators are tracking that behavior to a greater or lesser degree. The parameters can vary directly or inversely. However, as one key performance indicator varies, if another varies randomly, then there is no correlation. Additionally, the present invention can analyze behavior on any level where enough statistics exist to supply a meaningful result. The measurements can be taken within one or more wireless network cells, a cluster of wireless network cells, one or more switches, one or more other network devices, or at the network level.

When the present invention is applied, noise may be a consideration in determining the amount of data required to obtain significant results. This is actually a benefit of applying statistical techniques to communications networks in this manner: the noise can be averaged out by including enough data. If a graph of operating conditions is manually viewed, key performance indicators will vary due to a number of reasons, noise included. In many or most cases, there is no way to visually separate the noise or correlate key performance indicator behaviors; there are too many fluctuations and too much noise. The power of the present invention enables the user to “see through” and penetrate the noise and find the true cause of the problem. Of course, as the amount of noise increases, so does the amount of data needed to average it out. Additionally, if a correlation exists between key performance indicators and it is weak, then more data will be needed to make the correlation visible. However, if the correlation is strong, it will be obvious. These conclusions depend both on the size of the correlation and on its statistical error. The number of standard deviations away from zero that a measured correlation must attain before it can be judged statistically significant is a matter for the judgment of the investigator. Typically, three or four standard deviations are chosen as the criterion of significance, but it may be more, or even fewer, in some cases. Because the size of the standard deviation depends on the amount of data, the reason for collecting an adequate amount of data is apparent

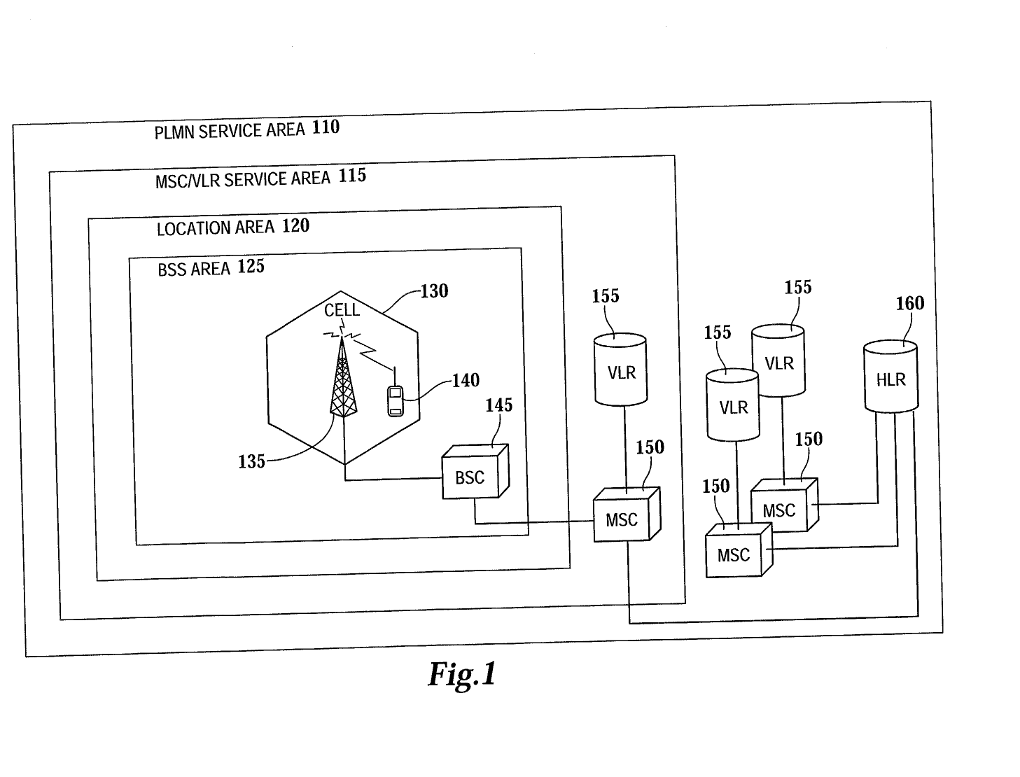

The present invention can be applied to a prior art communications network such as a Global System for Mobile Communication (“GSM”) Public Land Mobile Network (“PLMN”) as shown in FIG. 1. PLMN service area (or cellular network) 110 is composed of a number of MSC/VLR service areas 115, each with a Mobile Switching Center (“MSC”) 150 and a Visitor Location Register (“VLR”) 155. The MSC/VLR service areas 115 each include a number of location areas 120. Within a given location area 120, a mobile station 140 may move freely without having to send update location information to the MSC/VLR service area 115 that controls location area 120. Each location area 120 is further divided in a number of cells 130. Mobile station 140 is the physical equipment, such as a car phone or other portable phone, used by mobile subscribers to communicate with PLMN service area 110, each other, and users outside the subscribed network, both wireline and wireless.

Continuing with the GSM example, MSC 150 is in communication with at least one Base Station Controller (“BSC”) 145. BSC 145 is in contact with at least one Base Transceiver Station (“BTS”) 135. BTS 135 is the physical equipment, illustrated for simplicity as a radio tower, that provides radio coverage to the geographical part of cell 130 for which it is responsible. BSC 145 may be connected to several BTS's 135 and may be implemented as a stand-alone node or integrated with MSC 150. The BSC 145 and BTS 135 components are aggregately referred to as a Base Station System (“BSS”) 125.

PLMN service area 110 also includes a Home Location Register (“HLR”) 160, which is a database that maintains all subscriber information, such as user profiles, current location information, International Mobile Subscriber Identity (“IMSI”) numbers, and other administrative information. HLR 160 may be co-located with a given MSC 150 or, alternatively, can service multiple MSCs 150, as illustrated in FIG. 1.

VLR 155 is a database that contains information about each MSC 150 currently locating with the MSC/VLR service area 115. If a mobile station 140 roams into a new MSC/VLR service area 115, the VLR 155 that is connected to that MSC 150 will request data about the mobile station 140 from HLR 160 while simultaneously informing HLR 160 about the current location of mobile station 140. Accordingly, if the user of the mobile station 140 then wants to make a call, the local VLR 155 will have the requisite identification information without having to re-interrogate HLR 160. In accordance with this, the databases of VLR 155 and HLR 160 contain various subscriber information associated with a given mobile station 140.

The digital GSM system uses Time Division Multiple Access (“TDMA”) technology to handle radio traffic in each cell 130. TDMA divides each frequency into eight (8) time slots. However, with other TDMA systems, more or fewer time slots can be used. For example, in the D-AMPS system (also sometimes denominated “TDMA” specifically), each frequency is divided into six (6) time slots used in pairs to carry up to three calls. Logical channels are then mapped onto these physical channels. Examples of logical channels include traffic (speech) channels (“TCH”) and control channels (“CCH”).

Now turning back to the present invention, a multivariate (two or more random variables) analysis will be described to understand the relationships between different variables or parameters. Note that the terms variable and parameter are used interchangeably. The relationship between the different variables is assumed to be linear even though significant non-linear components may contribute to the relationship. However, over the limited range of variation usually encountered, these non-linear components normally play a small role compared with the statistical fluctuations and do not affect the results. The component of most interest is the slope of the line relating one variable to another. This slope measures the average response of one variable to conditions that cause changes in the other. This may mean that a change in one of the variables is the cause of the change in the other, but it may also mean that both variables are simply responding to some other set of changing conditions. A correlation coefficient, which is independent of the variables' units of measure, is used to measure this response. As a result, any two variables can be compared, regardless of their dimensions. Correlations or regression slopes are used to relate the variations of one variable to the variations in the other without regard to what their mean values are.

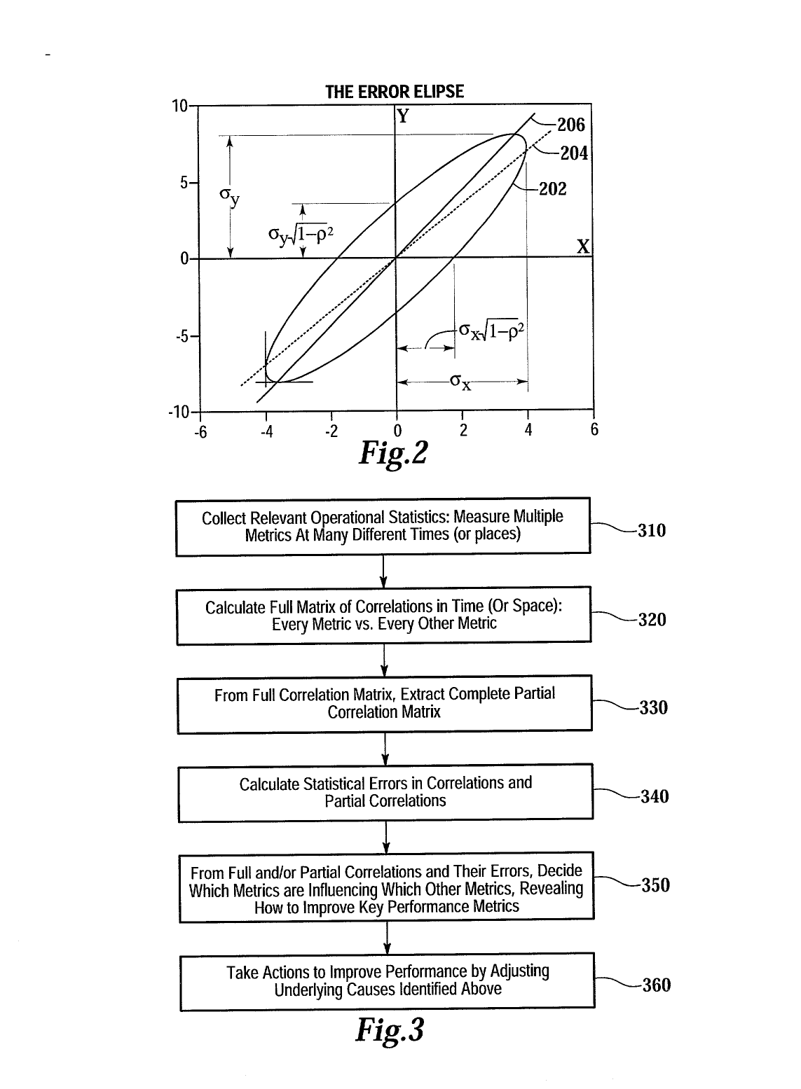

The correlation coefficient is illustrated in FIG. 2 through the use of the “error ellipse” 202. The error ellipse 202 illustrated is a one standard deviation ellipse where variable X and variable Y are approximately two-dimensional Gaussian with non-zero correlation. The error ellipse 202 will enclose approximately 39% of the data points. Variables X and Y may have different units and scales. Therefore the tilt of the error ellipse 202 on the plot will depend on the values of the standard deviation of X, σₓ, the standard deviation of Y, σ_{y}, and the correlation coefficient, ρ. The correlation coefficient, ρ, also determines the “fatness” or “thinness” of the error ellipse 202. Highly correlated variables lie almost on a straight line while uncorrelated variables will populate an ellipse that is at zero angle to one of the axes (which axis depends on which σ is larger), or circular if the standard deviations are the same. The dashed line 204 indicates the regression of Y on X, as in the first equation below, fit to the same data. The solid line 206 shows the regression fit of X on Y.

Partial correlations are used to take into account the indirect effects of other variables. For example, if variables A and B show a non-zero correlation, it may be that both A and B are dependent upon additional variables and that it is the variation of these other variables that causes the apparent dependency of A upon B. Partial correlations separate the direct dependence of A upon B from the indirect dependence that is due to third, fourth, etc., variables.

The data for the analysis includes a number of measurements that are made of a set of random variables wherein each measurement covers the complete set of variables. For example, the measurements may be analog traffic, digital traffic, and the number of dropped calls in a specified time period. That would be one measurement. The measurements are then repeated for a number of non-overlapping time periods, so that the measurements are independent. In another example, certain characteristics of a cell could be measured and those measurements could be repeated for a number of different cells. Each measurement is assumed to be complete, that is that there is no missing data where one time period or one cell might not have all the variables measured.

The cause-and-effect relationship between two variables, X and Y, might be detected by seeing the effect on Y of a change in X, or vice-versa. This could be a complex non-linear relationship, but to a first approximation it is often adequate to assume that they are linearly related:

Yₚ=a+bX, (1)

where a and b are constants which must usually be estimated from the data and Yₚ denotes the value of Y that is predicted by this equation when X is known. Yₚ then denotes the expected average value of Y upon determination of X. In a regression analysis, the difference between the measured Y, Yₘ, and the Y predicted from the above equation is assumed to be due to a random error ε:

Yₘ=a+bX+ε, (2)

where Yₘ is an actual measured value of Y at a known value of X. The ε term includes every source of variation of Y outside of the linear relationship with X. This could include a random measurement error, variations due to the effects of other variables that are also randomly varying, and random fluctuations in Y that have nothing to do with anything other than the nature of Y. For example, if Y is the traffic in a cell over a period of time then it will obviously have its own sources of random fluctuations from one time to another, there may be fluctuations arising from a correlation with other variables such as time of day or weather, and there may be measurement errors.

Then a and b can be estimated from least-squares, which means that the sum of the squares of the differences between the measured Yₘ and the predicted Y are minimized:

χ²=Σ(Yₚ_{ᵢ}−Yₘᵢ)²=Σεᵢ². (3)

Here, Yₘᵢ is the ith measured value of Y at Xₘᵢ the ith measured value of X, Yₚᵢ is the value of Yᵢ that would be predicted from Equation (1) and εᵢ is the actual error in the i^{th} measurement. Since the actual error is unknown, a and b are estimated using least-squares. The minimum value of χ2 obtains when

a=Ybar−b Xbar, (4)

and

b=Σ[(Xᵢ−Xbar)]/Σ(Yᵢ−Ybar)/Σ(Xᵢ−Xbar)². (5)

Here, Xbar and Ybar are the measured mean values of X and Y. The estimated variances in X and Y, σₓ²=[1/(m−1)]Σ(Xᵢ−Xbar)² and σ_{y}²=[1/(m−1)]Σ(Yᵢ−Ybar)² will be needed later. Here the number of points in the sample is m and the factor m−1, rather than m, is used to express the loss of precision due to the fact that the means of X and Y are not known but must themselves be estimated from the data.

Up to this point, X and Y are not treated equally. Y is expected to contain a measurement error and other sources of fluctuations. If X contains a measurement error then its value cannot be precisely known for this equation. However, provided that error is small then the equation is still valid. As for other sources of fluctuations, they do not rule out being able to determine what X really is, and the equation still works. If instead, measurement errors in Y are small, Equation (2) can be reversed and the average value of X can be predicted from a measured value of Y with an error term ε that would be different. In Equation (2), X is referred to as the predictor variable since the average value of Y can be predicted when X is known; in the reversed equation Y becomes the predictor variable. Equations (1) and (2) are referred to as the regression of Y upon X; in the reversed case, the regression of X upon Y. In the bivariate Gaussian case of FIG. 2, these two possible regression fits are sketched as dashed line 204 (Y upon X) and solid line 206 (X upon y). The premise of the least-squares estimate is that the error term ε, in either case, is at least approximately Gaussian and that the error in each of the m measurements has no influence upon any other, i.e., that the measurement errors are independent.

The Pearson correlation coefficient, ρ, is defined to express the relationship between two variables, X and Y, in a way that is independent of the units or scales of X and Y:

$$ρ = \sum [ ( {X}_{i} - Xbar ) ( {Y}_{i} - Ybar ) ] / \sqrt{[ {( \sum {X}_{i} - Xbar )}^{2} \sum {( {Y}_{i} - Ybar )}^{2} ]} . \qquad ( 6 )$$

Note that −1≦ρ≦1. Note also that although this does not depend on the scales of X or Y, when X vs. Y is plotted on a two-dimensional scatterplot, the visible slope of the line will depend on the scales of the plot axes. In addition, if this correlation is written as ρ_{xy}, then ρ_{xy}=ρ_{yx}. The correlation, ρ, not only expresses the slope but it also expresses the fatness or thinness of the ellipse that best describes the points.

Then the correlation, ρ, can be related to the slope of the regression line for Y upon X (Equation (5)) by

$$ρ = b {σ}_{x}^{2} / \sqrt{[ {σ}_{x}^{2} {σ}_{y}^{2} ]} . \qquad ( 7 )$$

So the correlation, ρ, expresses the regression slope in dimensionless units. Since the correlation, ρ, treats X and Y equivalently it refers to the slope of the major axis of the error ellipse 202. Note that this is not exactly the same line as found by regression of either X upon Y (solid line 206) or Y upon X (dashed line 204). Other equivalent expressions for the correlation, ρ, are sometimes more useful in calculations:

$$\begin{matrix}ρ = [ \sum ( {X}_{i} Y ) - mXbarYbar ] / [ ( m - 1 ) {σ}_{y} {σ}_{y} ] \\ = {[ m \sum ( {X}_{i} {Y}_{i} ) - ( \sum {X}_{i} ) ( \sum {Y}_{i} ) ]}^{2} / \\ \{ [ m \sum {X}_{i}^{2} - {( \sum {X}_{i} )}^{2} ] [ m \sum {Y}_{i}^{2} - {( \sum {Y}_{i} )}^{2} ] \} .\end{matrix} \qquad ( 8 )$$

The last form avoids some of the rounding errors that can occur in formulas using the means and standard deviations.

The correlation coefficient, ρ, looks at the variability of each variable X or Y and attempts to track whether the changes in X are reflected in changes in Y. Thus, if X and Y both tend to increase at the same time and decrease at the same time then we say that they are positively correlated. Likewise if they tend to vary oppositely then we say they are negatively correlated. The square of the correlation coefficient, ρ, indicates how strong this tracking is. If there is no significant tracking of one with the variations of another then the correlation coefficient, ρ, will be close to zero. A statistically significant correlation can indicate cause and effect, i.e., that one of the variables influences the other. But, there may be other influences causing both to fluctuate in concert.

The correlation coefficient, ρ, is sometimes called the simple correlation to distinguish it from other correlations. This can be generalized for random variables X₁, X₂, X₃, . . . , Xₚ by constructing a matrix of correlations M where the diagonal elements are 1.0 (which may be thought of as the expression of the correlation of a variable with itself) and the Mₖₗ element is Pₖₗ, where k and l now denote the kth and lth variables, Xₖ and Xₗ, respectively, not the kth and lth measurements. There are p different random variables assumed so M is a symmetric square matrix with p rows and columns. It can be shown that M is positive-definite (provided none of the ρₖₗ, for k≠l, terms equal plus or minus one).

Now the possibility that there are other variables that may affect the variations in measured values X₁ or X₂ is taken into account. For example, if a third variable, X₃, can affect both X₁ and X₂ it might appear that X₁ and X₂ are correlated with each other when in fact it is only the influence of the third variable that's causing both to fluctuate. Referring to Equation (2), ε may be larger than the random fluctuations plus measurement error in Y if Y is influenced by other randomly changing variables in addition to X.

Then the correlation between X₁ and X₂ can be regarded as a mixture of a direct part and an indirect part due to the presence of other variables correlating X₁ and X₂. The partial correlation between X₁ and X₂ expresses the direct part of the variation of X₁ with X₂ with the influence of all the other variables removed by linear regression. This is equivalent to holding all the other variables constant while X₁ and X₂ are varied in their natural random modes. The most general expression for the partial correlation between X₁ and X₂ controlling for the influences of variables X₃, X₄, . . . , Xₚ is

$$\begin{matrix}{ρ}_{12.34 … \cdot p} = [ {ρ}_{12} - {ρ}_{13}^{′} {M}_{33}^{- 1} {ρ}_{23} ] / \\ \sqrt[]{\{ ( 1 - {ρ}_{13} {M}_{33}^{- 1} {ρ}_{13} ] [ 1 - {ρ}_{23}^{′} {M}_{33}^{- 1} {ρ}_{23} ] \}} .\end{matrix} \qquad ( 9 )$$

In this equation, matrix M is portioned into three parts corresponding to X₁, X₂, and all the p-2 other X's:

$$M = ( \begin{matrix}1 & {ρ}_{12} & {ρ}_{13}^{′} \\ {ρ}_{21} & 1 & {ρ}_{23}^{ ′} \\ {ρ}_{13} & {ρ}_{23} & {M}_{33}\end{matrix} ) \begin{matrix}1 \\ 1 \\ p - 2\end{matrix} , \\ 1 \; 1 p - 2 \qquad ( 10 )$$

where the number of rows and columns in each element is indicated outside the matrix. Thus, ρ₁₃ is a p-2 by 1 vector of elements of M, but ρ₁₂ and ρ₂₁ are single-value scalers. The boldface denotes factors containing more than one element: either a vector or a matrix. The prime (′) indicates transpose. The present invention follows the convention in statistics that all vectors are column vectors. The lower right-hand corner M₃₃ is the p-2 by p-2 square symmetric matrix left over after rows 1 and 2 and the same columns are removed from M. For example, if there are only three variables (p=3), then

$${ρ}_{12.3} = [ {ρ}_{12} - {ρ}_{13} {ρ}_{23} ] / \sqrt{\{ [ 1 - {ρ}_{13}^{2} ] [ 1 - {ρ}_{23}^{2} ] \}} . \qquad ( 11 )$$

Note that M₃₃=1 if p=3, and for this special case all the ρ elements are scalers. It might appear that this could get outside the range [−1.0, 1.0] as ρ₁₃² or ρ₂₃² approach 1.0. However this is not the case due to the relations between the simple correlations owing to the fact that M is positive-definite. Therefore its determinant is positive and the determinant of every diagonal submatrix is also positive. Conceptually, if ρ₁₃ approaches 1 that means that variable 1 and 3 track each other nearly perfectly. Therefore variables 3 and 2 will track each other almost exactly the same as variables 1 and 2. Thus ρ₂₃ is approximately equal to ρ₁₂ and the numerator in Equation (11) goes to zero. Since the denominator is inside the square root, the numerator tends to zero faster than the denominator and the partial correlation remains finite and even approaches zero as ρ₁₃ approaches 1.0. M can be portioned with any two variables separated out in the same manner. In this way the partial correlation can be calculated for any two variables and a complete partial correlation matrix P constructed, symmetric, square, and positive definite the same as M.

The probability density function for p under the assumption that the errors ε are Gaussian is derived in Modern Multivariate Statistical Analysis: A Graduate Course and Handbook, Siotani, M., Hayakawa, T., and Fujikoshi, Y., American Sciences Press, Inc., Columbus, Ohio (1985), which is incorporated by reference. The standard deviation of this distribution is important because it provides an estimate of the statistical errors in a measurement of ρ. Unfortunately ρ is not a Gaussian random variable, even if X and Y are, which means that it is slightly more complicated than usual to estimate the errors. Given enough data, however, it will converge very slowly to an approximate Gaussian distribution. As a result of the slowness of this convergence, Fisher's z-transform is often used, in which the variable

$$z ≡ {tanh}^{- 1} ( ρ ) = \frac{1}{2} log [ \frac{1 + ρ}{1 - ρ} ] , \qquad ( 12 )$$

is calculated, which turns out to converge more rapidly to a Gaussian. Here the logarithm is the natural logarithm (base e). Fisher's z is approximately unbiased with a standard deviation of approximately

$${σ}_{z} = \sqrt{Var ( z )} = [ \frac{1}{m - 4} ] . \qquad ( 13 )$$

Here, m is the number of data points. This can be transformed back to a standard deviation in ρ:

$$\begin{matrix}{σ}_{p}^{+} = \{ exp [ 2 ( z + {σ}_{z} ) ] - 1 \} / \{ exp [ 2 ( z + {σ}_{z} ) ] + 1 \} - ρ \\ {σ}_{p}^{-} = ρ - \{ exp [ 2 ( z - {σ}_{z} ) ] - 1 \} / \{ exp [ 2 ( z - {σ}_{z} ) ] + 1.\end{matrix} \qquad ( 14 )$$

Because of the asymmetric nature of the distribution of ρ, the errors are asymmetric and the standard deviation going up differs from the standard deviation going down. This just expresses the fact that if, for example, ρ is close to 1.0 then the downward error should be larger than the upward error, since it makes little sense to have an error estimate that goes above 1.0. Statistical errors in the partial correlations are calculated in a similar way as the statistical errors in the simple correlations. The only difference is that m−4 in Equation (13) is replaced with m−6. This reflects the fact that the partial correlations have somewhat larger errors than the simple correlations.

If the variables X and Y are not Gaussian then these errors are only approximate. Their validity will depend on the ranges of the observations. If only a small range of values is covered then it's more difficult to get an accurate estimate of the correlation or regression parameters and the errors are assumed not to be large enough. On the other hand if the data pretty much cover a very wide range of values with not a very rapid falloff at large values then the estimates may be better than otherwise expected.

A more serious problem for partial correlations occurs if there is missing data. In this case, although the estimators for the simple correlations are unbiased, they may have statistical errors that do not satisfy the assumptions for errors in partial correlations. If the data is sufficient, then the problems are not severe. But if the data is not sufficient, the correlation matrix may not even be positive definite. This is because the data used to estimate ρ_{xy} might not be the same as the data for ρ_{xz}, where x, y, and z are any three of the variables. Normally, statistical fluctuations in one compensate for the fluctuations in the other since they come from the same data. If not, the fluctuations might cause the denominator in Equations (9) or (11) to become imaginary. In such a case, complex partial correlations would result, which is a sure sign that the calculation is not usable. With sufficient data, of course, the precision in the ρ_{xy}'s will be adequate to provide useful partial correlations. The cure for this difficulty therefore lies in collecting more data.

A second problem sometimes occurs due to round-off error in calculating the partial correlations. Computer double precision may not be adequate for problems involving a large number of variables because calculation of the matrix inverses in Equation (9) requires the subtraction of numbers that are nearly equal, and maintaining the precision may be beyond the capability of computer double precision. The size of the determinant of M will help determine if the calculation is going to work. Again, reducing the statistical errors by collecting more data will often help. Otherwise, the problem must be addressed by using sophisticated numerical techniques and/or higher precision in the calculations.

Referring now to FIG. 3, a flowchart of a process in accordance with the present invention is illustrated. The relevant operational statistics are collected by measuring multiple metrics or parameters at many different times or places in block 310. Using the collected metrics or parameters from block 310, a full matrix of correlations is calculated in time or space of every metric or parameter versus every other metric or parameter in block 320. From the full correlation matrix calculated in block 320, a complete partial correlation matrix is extracted in block 330. Next, in block 340, the statistical errors in the correlations and the partial correlations are calculated. Then, from the full and/or partial correlations and their errors, a decision is made in block 350 regarding which metrics or parameters are influencing which other metrics or parameters, thereby revealing how to improve key performance metrics or parameters. Finally, actions are taken in block 360 to improve performance by adjusting the underlying causes identified in block 350.

The size of the matrices used by the present invention depends on the number of variables that are likely to be contributing to a problem. If too many variables are included, not only could the problem remain masked, but the calculation could become computationally unwieldy. If too few variables are used, the problem variable may be omitted. From a mathematical viewpoint, the size of the matrix is unlimited. From a computational viewpoint, there are limitations. Using standard consumer level computers, the accuracy suffers from the inadequacy of computer double precision as mentioned above if a matrix contains more than approximately 15 or 20 variables. Software precision limitations should also be considered. If there are a lot of terms, round-off errors may produce nonsense results. Methods for managing round-off errors in calculations are well known to those skilled in the art.

The present invention can implemented as a computer program in a local or distributed processing environment and can function in real-time, near real-time or offline. The computer program, which would be resident on a computer readable medium, would obtain a set of measurements for two or more parameters within the communications network. Thereafter, a correlation between each of the two or more parameters and a partial correlation between each of the two or more parameters is determined. Next, a determination as to whether the correlations and the partial correlations are statistically significant is made. Finally, a determination is made as to whether the two or more parameters, if any, influence one another based on the statistically significant correlations and partial correlations. Such a computer program can be implemented into a system including a computer, a data storage mechanism (such as a database or file) communicably coupled to the computer and an interface communicably coupled to the computer for communicably coupling the computer to one or more network devices.

When implementing the present invention in the telecommunications world, correlation thresholds relevant to telecommunications would be employed. Alternatively, or additionally, error estimation techniques well known to those skilled in the art may be used. Once the errors have been calculated, they can be used to decide if a correlation is statistically significant. If a correlation is not statistically significant, it may mean that more data is needed or that the cause of the problem lies elsewhere. More data and further calculations may be needed to decrease the statistical errors enough to satisfy the user.

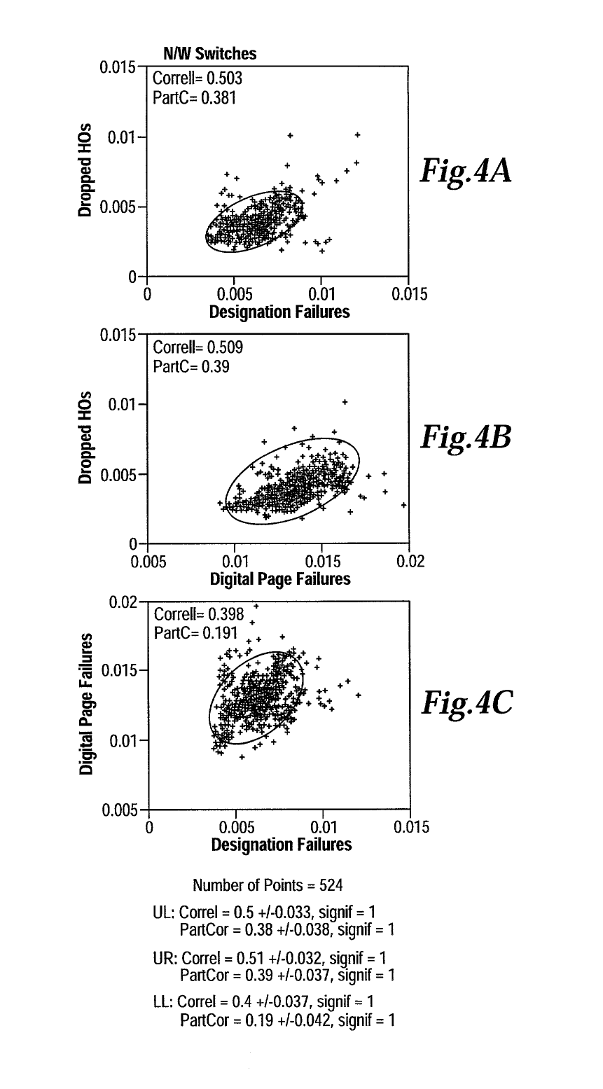

Turning now to FIGS. 4A, 4B and 4C, graphs of correlations between two parameters in a communications network using the present invention are shown. FIG. 4A is a graph of dropped handoffs versus designation failures. FIG. 4B is a graph of dropped handoffs versus digital page failures. FIG. 4C is a graph of digital page failures versus designation failures. Collectively, FIGS. 4A, 4B and 4C illustrate the relationship between the dropped handoffs, digital page designation failures, and designation failures over a period of time. Correlations (indicated in each graph by “Correl=”) signify the degree of linear association between pairs of variables. In other words, how much the changes in one are accompanies by changes in the other. The partial correlation between a pair of parameters signifies the same after correction for the variation due to the third parameter. For example, as shown in FIG. 4C, digital page failures (the third parameter) are about 40% correlated (“Correl=0.398”) with voice channel designation failures (the second parameter). But only about 19% (“PartC=0.191”) is due to a direct correlation. The remainder comes from the relation between these two parameters and the first parameter, handoffs. Thus, variations in the dropped handoff rate cause variations in both the digital page failure rate and the designation failure rate and that causes about half of their correlation. There may also be other variables that have not been included here that could be causing some of the rest of the correlation. Therefore, the partial correlations (“PartC”) will depend on whether or not all variables that influence the three graphed are included. The ellipses on each graph show an approximate two-standard-deviation contour about the common means.

In the above example, an engineer skilled in the art will know that both designation failures and paging failures are aspects of call access failures and that dropped handoffs can only occur following successful access. Therefore, it cannot be said that one of these is a direct cause of another. Rather, it can be said that there are conditions in the network, such as coverage problems or interference problems, which must be a common cause for all three.

Although preferred embodiments of the present invention have been described in detail, it will be understood by those skilled in the art that various modifications can be made therein without departing from the spirit and scope of the invention as set forth in the appended claims.

What is claimed is:

1. A method for determining whether two or more parameters influence one another within a communications network, comprising the steps of:
obtaining a set of measurements for two or more parameters within the communications network;
determining a correlation between each of the two or more parameters;
determining a partial correlation between each of the two or more parameters;
determining whether the correlations and the partial correlations are statistically significant; and
determining whether the two or more parameters, if any, influence one another based on the statistically significant correlations and partial correlations.

2. The method as recited in claim 1, wherein the two or more parameters include a key performance indicator.

3. The method as recited in claim 1, wherein the two or more parameters include an indicator of network accessibility.

4. The method as recited in claim 1, wherein the two or more parameters include an indicator of service quality.

5. The method as recited in claim 1, wherein the two or more parameters include an indicator of dropped handoffs.

6. The method as recited in claim 1, wherein the two or more parameters include an indicator of designation failures.

7. The method as recited in claim 1, wherein the two or more parameters include an indicator of digital page failures.

8. The method as recited in claim 1, wherein the two or more parameters are measured within one or more wireless network cells.

9. The method as recited in claim 1, wherein the two or more parameters are measured within a cluster of wireless network cells.

10. The method as recited in claim 1, wherein the two or more parameters are measured at one or more switches.

11. The method as recited in claim 1, wherein the two or more parameters are measured at a network level.

12. The method as recited in claim 1, further comprising the step of storing the measurements for the two or more parameters in a data storage mechanism.

13. The method as recited in claim 1, wherein the step of obtaining the set of measurements for the two or more parameters comprises the step of retrieving the set of measurements for the two or more parameters from a data storage mechanism.

14. The method as recited in claim 1, wherein the step of obtaining the set of measurements for the two or more parameters comprises the steps of:
requesting the set of measurements for the two or more parameters from one or more network devices; and
receiving the set of measurements for the two or more parameters from one or more network devices.

15. The method as recited in claim 1, further comprising the steps of:
identifying a problem within the communications network;
identifying the two or more parameters that relate to the problem; and
using the parameters that influence one another to solve the problem.

16. A computer program embodied on a computer readable medium for determining whether two or more parameters influence one another within a communications network, comprising:
a code segment for obtaining a set of measurements for the two or more parameter within the communications network;
a code segment for determining a correlation between each of the two or more parameters;
a code segment for determining a partial correlation between each of the two or more parameters;
a code segment for determining whether the correlations and the partial correlations are statistically significant; and
a code segment for determining whether the two or more parameters, if any, influence one another based on the statistically significant correlations and partial correlations.

17. The computer program as recited in claim 16, wherein the two or more parameters include a key performance indicator.

18. The computer program as recited in claim 16, wherein the two or more parameters include an indicator of network accessibility.

19. The computer program as recited in claim 16, wherein the two or more parameters include an indicator of service quality.

20. The computer program as recited in claim 16, wherein the two or more parameters include an indicator of dropped handoffs.

21. The computer program as recited in claim 16, wherein the two or more parameters include an indicator of designation failures.

22. The computer program as recited in claim 16, wherein the two or more parameters include an indicator of digital page failures.

23. The computer program as recited in claim 16, wherein the two or more parameters are measured within one or more wireless network cells.

24. The computer program as recited in claim 16, wherein the two or more parameters are measured within a cluster of wireless network cells.

25. The computer program as recited in claim 16, wherein the two or more parameters are measured at one or more switches.

26. The computer program as recited in claim 16, wherein the two or more parameters are measured at a network level.

27. The computer program as recited in claim 16, further comprising a code segment for storing the measurements for the two or more parameters in a data storage mechanism.

28. The computer program as recited in claim 16, wherein the code segment for obtaining the set of measurements for the two or more parameters comprises a code segment for retrieving the set of measurements for the two or more parameters from a data storage mechanism.

29. The computer program as recited in claim 16, wherein the code segment for obtaining the set of measurements for the two or more parameters comprises:
a code segment for requesting the set of measurements for the two or more parameters from one or more network devices; and
a code segment for receiving the set of measurements for the two or more parameters from one or more network devices.

30. A system for determining whether two or more parameters influence one another within a communications network, comprising:
a computer;
a data storage mechanism communicably coupled to the computer;
an interface communicably coupled to the computer for communicably coupling the computer to one or more network devices; and
the computer obtaining a set of measurements for the two or more parameters within the communications network, determining a correlation between each of the two or more parameters, determining a partial correlation between each of the two or more parameters, determining whether the correlations and the partial correlations are statistically significant, and determining whether the two or more parameters, if any, influence one another based on the statistically significant correlations and partial correlations.

31. The system as recited in claim 30, wherein the two or more parameters include a key performance indicator.

32. The system as recited in claim 30, wherein the two or more parameters include an indicator of network accessibility.

33. The system as recited in claim 30, wherein the two or more parameters include an indicator of service quality.

34. The system as recited in claim 30, wherein the two or more parameters include an indicator of dropped handoffs.

35. The system as recited in claim 30, wherein the two or more parameters include an indicator of designation failures.

36. The system as recited in claim 30, wherein the two or more parameters include an indicator of digital page failures.

37. The system as recited in claim 30, wherein the two or more parameters are measured within one or more wireless network cells.

38. The system as recited in claim 30, wherein the two or more parameters are measured within a cluster of wireless network cells.

39. The system as recited in claim 30, wherein the two or more parameters are measured at one or more switches.

40. The system as recited in claim 30, wherein the two or more parameters are measured at a network level.

41. The system as recited in claim 30, wherein the computer stores the measurements for the two or more parameters in the data storage mechanism.

42. The system as recited in claim 41, wherein the computer obtains the set of measurements for the two or more parameters from the data storage mechanism.

43. The system as recited in claim 41, wherein the computer obtains the set of measurements for the two or more parameters by requesting the set of measurements for the two or more parameters from the one or more network devices via the interface, and receiving the set of measurements for the two or more parameters from one or more network devices via the interface.
